(19) United States
(12) Patent Application Publication
(10) Pub. No.: US 2013/0088472 A1
(43) Pub. Date: Apr. 11, 2013

(54) VISUAL DISPLAY CONNECTION CIRCUIT

(71) Applicants: JIN-LIANG XIONG, Shenzhen City (CN); HAI-QING ZHOU, Shenzhen City (CN); YI-XIN TU, Shenzhen City (CN)

(72) Inventors: JIN-LIANG XIONG, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/329,341

(22) Filed: Dec. 19, 2011

(30) Foreign Application Priority Data
Oct. 11, 2011 (CN) 201110306251.9

(51) Int. Cl. G09G 5/00

(52) U.S. Cl. 345/211

(57) ABSTRACT

A connection circuit for a digital visual interface (DVI) includes a platform controller hub (PCH), a DVI, a plurality of voltage dividing resistors, and a switch. The platform controller hub (PCH) includes a plurality of output contacts outputting a plurality of analog signals. The DVI includes a plurality of input contacts, and each input contact is connected to one of the output contacts to transmit the analog signals. The switch has one end connected to the output contacts, and another end grounded. The switch switches on when a power supply is applied to the switch and is switched off when the power supply is not applied to the switch.

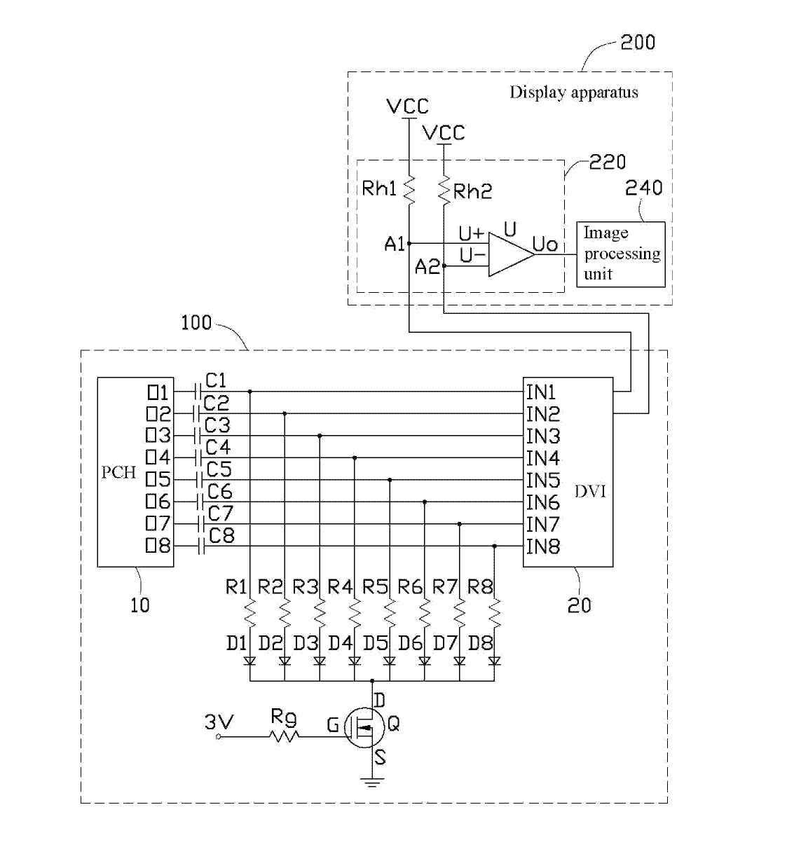

### BACKGROUND

1. Technical Field

The disclosure generally relates to connection circuits, and particularly to a connection circuit used to transmit image information from a computer to a display apparatus such as a liquid crystal display (LCDs), or a projector.

2. Description of Related Art

Many display apparatuses such as LCDs and projectors are connected to a computer via a connection circuit such as a digital visual interface (DVI) and receive image data from the computer. Because most of the display apparatuses can only receives digital signals from the computer, an D/A conversion circuit is commonly is used in the display apparatuses. However, when the computer is powered off or in a sleep mode and stops transmitting image information to the display apparatuses, the A/D conversion circuit may continue to consume power.

Therefore, there is room for improvement within the art.

### BRIEF DESCRIPTION OF THE DRAWING

Many aspects of the present disclosure can be better understood with reference to the following drawing. The elements in the drawing are not necessarily drawn to scale, the emphasis instead being placed upon clearly illustrating the principles of the disclosure.

The FIGURE is a circuit diagram of a connection circuit connected to a display apparatus, according to an exemplary embodiment of the disclosure.

### DETAILED DESCRIPTION

Referring to the FIGURE, an exemplary embodiment of a connection circuit 100 for electronic devices such as computers and servers includes a platform controller hub (PCH) 10 for electronically connecting to display devices such as LCDs and projectors, is illustrated. The connection circuit 100 includes a DVI 20 (DVI-I, or DVI-A), a plurality of capacitors C1-C8, a switch Q, a plurality of diodes D1-D8, and a plurality of voltage dividing resistors R1-R8.

The PCH 10 includes a plurality of signal output contacts O1-O8 configured for outputting four groups of analog signals (i.e. eight paths). One group of the analog signals includes a pair of differential clock signals, noted as CLK-DN and CLK-DP, which are alternating current (AC) voltages. The other three groups of analog signals include pairs of differential image signals, noted as TX1-DN, TX1-DP, TX2-DN, TX2-DP, TX3-DN, and TX3-DP, which are also alternating current (AC) voltages.

The DVI 20 includes at least eight input contacts IN1-IN8. The input contacts IN1-IN8 are respectively connected to the output contacts O1-O8 with one capacitor C1-C8 per output contact O1-O8. The input contacts IN1-IN8 receive the analog signals along eight paths from PCH 10. In this embodiment, the eight input contacts IN1-IN8 include two analog contacts for red, two analog contacts for blue, two analog contacts for green, an analog horizontal synchronization contact, and an analog vertical synchronization contact of a standard DVI-I interface or DVI-A interface.

In this embodiment, the switch Q is a depletion metal-oxide-semiconductor field effect transistor (D-MOSFET) having a source S grounded, a gate G receiving a signal from a computer, such as a 3V signal via a resistor Rg, and a drain D connected to the cathodes of all the diodes D1-D8. Each of the anodes of the diodes D1-D8 is respectively connected to one of the nodes N1-N8 between the capacitors C1-C8 and the DVI 20, through one of the voltage dividing resistors R1-R8.

The display apparatus 200 is electronically connected to the DVI 20 through a DVI cable (not shown). The display apparatus 200 includes a plurality of comparing circuits 220 and an image processing unit 240. In this embodiment, the display apparatus 200 includes four comparing circuits 220. For ease of understanding, only one comparing circuit 220 is shown in the FIGURE. Each comparing circuit 220 includes two pull-up resistors Rh1, Rh2 and a comparator U. A non-inverting input terminal U+ and an inverting input terminal U− of the comparator U are respectively connected to the input contacts IN1, IN2, and also respectively connected to a power supply VCC via a pull-up resistor of the two pull-up resistors Rh1, Rh2. An output terminal Uo of the comparator U is connected to the image processing unit 240.

In use, the display apparatus 200 is electronically connected to the DVI 20 of the computer by a DVI cable, and the computer is powered on, the PCH 10 outputs the four groups of analog signals, the transistor Q is turned on when a 3V voltage is received at the gate G. A voltage at the drain D is pulled down, and the diodes D1-D8 are turned on. The pull-up resistors Rh1, Rh2 are respectively connected to the voltage dividing resistors R1, R2 and also grounded by the transistor Q. Thus, the pull-up resistors Rh1, Rh2 form a circuit loop with the voltage dividing resistor R1, R2 and the power supply.

One pair of the differential signals, such as the differential clock signals CLK-DN and CLK-DP are output from the output contacts O1, O2 and respectively applied to the node A1 and to the node A2. Each of the pair of differential clock signals CLK-DN and CLK-DP has the same voltage, but each has a different current direction. Thus, the voltage of the node A1 is different from the voltage of the node A2. The comparator U compares the voltage of the node A1 with that of the node A2 and outputs a digital signal according to the comparison. Therefore, the analog signals output from the output contacts O1, O2 are converted to digital signals.

Accordingly, the analog signals output from the other output contacts O3-O8 are also converted to digital signals. The image processing unit 240 receives the digital signals and displays a corresponding image.

When the computer is powered off or in a sleep mode, the PCH 10 does not output any analog signal to the DVI 20 and the transistor Q cannot receive any 3V signal. The diodes D1-D2 turn off. The voltage dividing resistors R1-R8 do not supply any power.

In another embodiment, the diodes D1-D2 are omitted, the drain D of the transistor Q may be directly connected to the voltage dividing resistors R1-R8.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A connection circuit for a digital visual interface (DVI) comprising:
a platform controller hub (PCH) comprising a plurality of output contacts outputting a plurality of analog signals;
a DVI comprising a plurality of input contacts, and each of the input contacts connected to one of the output contacts for transmission of the analog signals; and
a switch comprising a first end connected to the output contacts, and a second end grounded, the switch switching on when a power supply is applied to the switch and switching off when the power supply is not applied to the switch.

2. The connection circuit of claim 1, wherein the switch is a transistor, a source of the transistor is grounded, a drain of the transistor is connected to the output contacts by one voltage dividing resistor per contact, a gate of the transistor is connected to the power supply.

3. The connection circuit of claim 1, further comprising a plurality of capacitors, each of the capacitors is connected between one of the output terminals and one of the corresponding input terminals.

4. The connection circuit of claim 2, wherein a first end of each voltage dividing resistor is connected to a node between one of the capacitors and one of the corresponding output terminals, and a second end of each of the voltage dividing resistors are connected to the drain of the transistor.

5. The connection circuit of claim 4, further comprising a plurality of diodes, each of the diodes connected between one of the voltage dividing resistors and the drain of the transistor.

6. The connection circuit of claim 1, further comprising a resistor connected to the gate of the transistor.

7. A connection circuit in electronic communication with a display apparatus, wherein the display apparatus comprises a plurality of comparators and an image processing unit, each comparator comprises a non-inverting terminal and an inverting terminal which are respectively connected to a power supply via a pull-up resistor, and an output terminal connected to the image processing unit, the connection circuit comprising:
a platform controller hub (PCH) comprising a plurality of output contacts;
a digital visual interface (DVI), the DVI comprising a plurality of input contacts respectively connected to one of the output contacts, and also connected to the non-inverting terminal and the inverting terminal of each comparator;
a plurality of voltage dividing resistors; and
a transistor, a source of the transistor being grounded, a drain of the transistor being connected to the output contacts by one voltage dividing resistor per contact.

8. The connection circuit of claim 7, further comprising a plurality of capacitor, each of the capacitors is connected between one of the output terminals and one of the corresponding input terminals.

9. The connection circuit of claim 7, wherein a first end of each voltage dividing resistor is connected to a node between one of the capacitors and one of the corresponding output terminals; a second end of each voltage dividing resistor is connected to the drain of the transistor.

10. The connection circuit of claim 9, further comprising a plurality of diodes, each diode is connected between one of the voltage dividing resistors and the drain of the transistor.

11. A connection circuit in electronic communication with a display apparatus, wherein the display apparatus comprises a plurality of comparators and an image processing unit, each comparator comprises a non-inverting terminal and an inverting terminal which are respectively connected to a power supply by a pull-up resistor, and an output terminal connected to the image processing unit, the connection circuit comprising:
a platform controller hub (PCH), comprising a plurality of output contacts;
a digital visual interface (DVI), the DVI comprising a plurality of input contacts respectively connected to one of the output contacts, and also connected to the non-inverting terminal and the inverting terminal of each comparator;
a plurality of voltage dividing resistors; and
a transistor connected to nodes between the input contacts and the output contacts via the voltage dividing resistors, the transistor controlling the pull-up resistors to connect to the voltage dividing resistors and form a circuit loop with the voltage dividing resistors and the power supply or disconnect from the voltage dividing resistors according to a control signal.

12. The connection circuit of claim 11, further comprising a plurality of capacitor, each of the capacitors is connected between one of the output terminals and one of the corresponding input terminals.

13. The connection circuit of claim 11, wherein a first end of each voltage dividing resistor is connected to a node between one of the capacitors and one of the corresponding output terminals; a second end of each voltage dividing resistor is connected to the drain of the transistor.

14. The connection circuit of claim 11, further comprising a plurality of diodes, each diode is connected between one of the voltage dividing resistors and the drain of the transistor.
